(19) United States
(12) Patent Application Publication
(10) Pub. No.: US 2023/0085304 A1
(43) Pub. Date: Mar. 16, 2023

(54) SIGNALING CODING PARAMETERS IN VIDEO CODING

(71) Applicant: InterDigital VC Holdings France, Cesson-Sevigne (FR)

(72) Inventors: Karam NASER, Cesson-Sevigne (FR); Fabrice LE LEANNEC, Betton (FR); Philippe DE LAGRANGE, Cesson-Sevigne (FR); Tangi POIRIER, Cesson-Sevigne (FR); Edouard FRANCOIS, Cesson-Sevigne (FR); Franck HIRON, Cesson-Sevigne (FR); Christophe CHEVANCE, Brece (FR); Michel KERDRANVAT, Chantepie (FR)

(21) Appl. No.: 17/797,075

(22) PCT Filed: Mar. 22, 2021
(86) PCT No.: PCT/EP2021/057199

§ 371 Date: Aug. 2, 2022

(30) Foreign Application Priority Data
Mar. 26, 2020 (EP) 20315055.2
Mar. 30, 2020 (EP) 20315080.0
Mar. 31, 2020 (EP) 20315088.3

(51) Int. Cl. H04N 19/70; H04N 19/117; H04N 19/82; H04N 19/186; H04N 19/172

(52) U.S. Cl. CPC H04N 19/70; H04N 19/117; H04N 19/82; H04N 19/186; H04N 19/172

(57) ABSTRACT

In some chroma formats, monochrome processing is performed for each color component. For example, for 4:0:0, only luma components exist, and all chroma related syntax and code are not used. In addition, for 4:4:4 when separable color plane is activated, the chroma components are treated as independent luma components, and the codec may behave as if no chroma is present at all and no chroma related tools are used. To reduce redundancy in coding parameters related to chroma, in one implementation, a flag indicating the availability of chroma components is coded. In another implementation, inter-related syntax is omitted in an intra-only coding mode for video data. In addition, slice level control of LMCS is provided.

### TECHNICAL FIELD

The present embodiments generally relate to a method and an apparatus for signaling coding parameters in video encoding or decoding.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY

According to an embodiment, a method of video decoding is provided, comprising: decoding a syntax indicating whether chroma ALF (Adaptive Loop Filter) data are present in a bitstream; decoding ALF filter data for a luma component of a picture; and responsive to said chroma ALF data being present in said bitstream, decoding ALF filter data for one or more chroma components of said picture.

According to another embodiment, a method of video encoding is provided, comprising: encoding a syntax indicating whether chroma ALF (Adaptive Loop Filter) data are present in a bitstream; encoding ALF filter data for a luma component of a picture; and responsive to said chroma ALF data being present in said bitstream, encoding ALF filter data for one or more chroma components of said picture.

According to another embodiment, a method of video decoding is provided, comprising: decoding a syntax indicating whether chroma LMCS (Luma Mapping with Chroma Scaling) data are present in a bitstream; decoding LMCS data for a luma component of a picture; and responsive to said chroma LMCS data being present in said bitstream, decoding LMCS data for one or more chroma components of said picture.

According to another embodiment, a method of video encoding is provided, comprising: encoding a syntax indicating whether chroma LMCS (Luma Mapping with Chroma Scaling) data are present in a bitstream; encoding LMCS data for a luma component of a picture; and responsive to said chroma LMCS data being present in said bitstream, encoding LMCS data for one or more chroma components of said picture.

According to another embodiment, an apparatus for video decoding is presented, comprising one or more processors, wherein said one or more processors are configured to: decode a syntax indicating whether chroma ALF (Adaptive Loop Filter) data are present in a bitstream; decode ALF filter data for a luma component of a picture; and responsive to said chroma ALF data being present in said bitstream, decode ALF filter data for one or more chroma components of said picture.

According to another embodiment, an apparatus for video decoding is presented, comprising one or more processors, wherein said one or more processors are configured to: encode a syntax indicating whether chroma ALF (Adaptive Loop Filter) data are present in a bitstream; encode ALF filter data for a luma component of a picture; and responsive to said chroma ALF data being present in said bitstream, encode ALF filter data for one or more chroma components of said picture.

According to another embodiment, an apparatus for video decoding is presented, wherein said one or more processors are configured to: decode a syntax indicating whether chroma LMCS (Luma Mapping with Chroma Scaling) data are present in a bitstream; decode LMCS data for a luma component of a picture; and responsive to said chroma LMCS data being present in said bitstream, decode LMCS data for one or more chroma components of said picture.

According to another embodiment, an apparatus for video decoding is presented, wherein said one or more processors are configured to: encode a syntax indicating whether chroma LMCS (Luma Mapping with Chroma Scaling) data are present in a bitstream; encode LMCS data for a luma component of a picture; and responsive to said chroma LMCS data being present in said bitstream, encode LMCS data for one or more chroma components of said picture.

According to another embodiment, an apparatus for video decoding is presented, comprising: means for decoding a syntax indicating whether chroma ALF (Adaptive Loop Filter) data are present in a bitstream; means for decoding ALF filter data for a luma component of a picture; and responsive to said chroma ALF data being present in said bitstream, means for decode ALF filter data for one or more chroma components of said picture.

According to another embodiment, an apparatus for video decoding is presented, comprising: means for encoding a syntax indicating whether chroma ALF (Adaptive Loop Filter) data are present in a bitstream; means for encoding ALF filter data for a luma component of a picture; and responsive to said chroma ALF data being present in said bitstream, means for encoding ALF filter data for one or more chroma components of said picture.

According to another embodiment, an apparatus for video decoding is presented, comprising: means for decoding a syntax indicating whether chroma LMCS (Luma Mapping with Chroma Scaling) data are present in a bitstream; means for decoding LMCS data for a luma component of a picture; and responsive to said chroma LMCS data being present in said bitstream, means for decoding LMCS data for one or more chroma components of said picture.

According to another embodiment, an apparatus for video decoding is presented, comprising: means for encoding a syntax indicating whether chroma LMCS (Luma Mapping with Chroma Scaling) data are present in a bitstream; means for encoding LMCS data for a luma component of a picture; and responsive to said chroma LMCS data being present in said bitstream, means for encoding LMCS data for one or more chroma components of said picture.

According to another embodiment, a method for encoding picture information is presented, comprising: obtaining control information to control a chroma scaling at a slice level of the picture information; and encoding at least a portion of the picture information based on the control information.

According to another embodiment, a method for decoding encoded picture information is provided, comprising: obtaining control information to control a chroma scaling at a slice level of the encoded picture information; and decoding at least a portion of the encoded picture information based on the control information.

According to another embodiment, an apparatus for encoding picture information is provided, comprising: one or more processors configured to generate control information to control a chroma scaling at a slice level of the picture information; and encode at least a portion of the picture information based on the control information.

According to another embodiment, an apparatus for decoding encoded picture information is provided, comprising: one or more processors configured to obtain control information to control a chroma scaling at a slice level of the encoded picture information; and decode at least a portion of the encoded picture information based on the control information.

According to another embodiment, a method is provided, comprising: encoding video data wherein said video data comprises luminance only data or comprises intra coded only data; and, including in a bitstream said encoded video data and syntax indicative of luminance only data or intra coded only data.

According to another embodiment, a method is provided, comprising: parsing a video bitstream comprising video data for syntax indicative of luminance only data or intra coded only data; and, decoding said video data using syntax indicative of luminance only data or intra coded only data.

One or more embodiments also provide a computer program comprising instructions which when executed by one or more processors cause the one or more processors to perform the encoding method or decoding method according to any of the embodiments described above. One or more of the present embodiments also provide a computer readable storage medium having stored thereon instructions for encoding or decoding video data according to the methods described above.

One or more embodiments also provide a computer readable storage medium having stored thereon a bitstream generated according to the methods described above. One or more embodiments also provide a method and apparatus for transmitting or receiving the bitstream generated according to the methods described above.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder.

FIG. 3 illustrates a block diagram of an embodiment of a video decoder.

FIG. 4 illustrates a process of decoding the ALF (Adaptive Loop Filter) data, according to an embodiment.

FIG. 5 illustrates a method of generating control information for video encoding or decoding, according to an embodiment.

FIG. 6 illustrates a process for providing control information, according to an embodiment.

### DETAILED DESCRIPTION

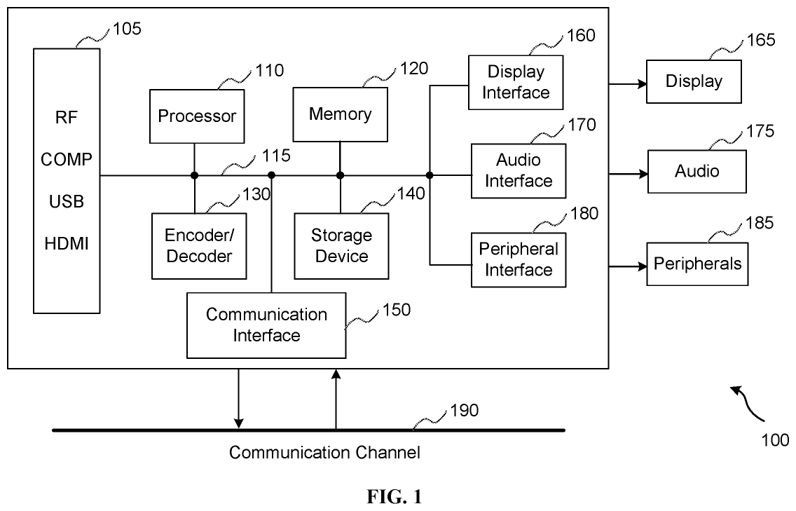

FIG. 1 illustrates a block diagram of an example of a system in which various aspects and embodiments can be implemented. System 100 may be embodied as a device including the various to components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). system 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

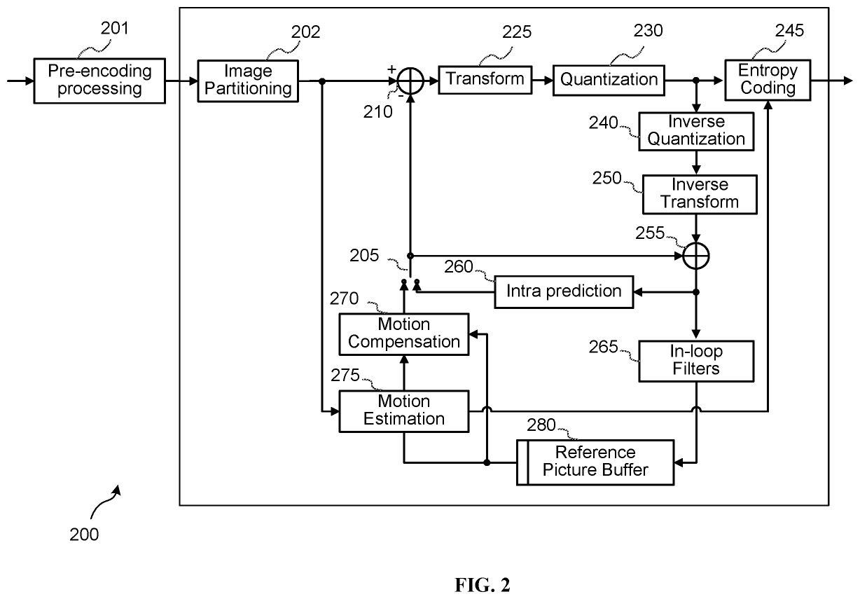

FIG. 2 illustrates an example video encoder 200, such as a High Efficiency Video Coding (HEVC) encoder. FIG. 2 may also illustrate an encoder in which improvements are made to the HEVC standard or an encoder employing technologies similar to HEVC, such as a VVC (Versatile Video Coding) encoder under development by JVET (Joint Video Exploration Team).

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

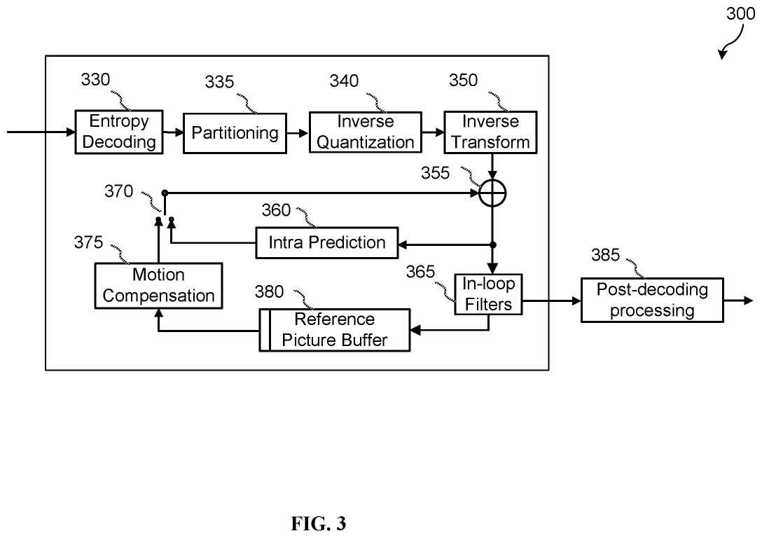

FIG. 3 illustrates a block diagram of an example video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

ALF, LMCS and Scaling Matrix Signaling in APS

In VVC draft 8 (see B. Bross, et al., “Versatile Video Coding (Draft 8),” Document: JVET-Q2001, Joint Video Experts Team (JVET) of ITU-T SG 16 WP 3 and ISO/IEC JTC 1/SC 29/WG 11, 17th Meeting: Brussels, BE, 7-17 Jan. 2020), APS (Adaptation Parameter Set) contains the parameters of ALF (Adaptive Loop Filter), LMCS (Luma Mapping with Chroma Scaling) and scaling matrices. In VVC draft 8, APS is coded as follows:

| adaptation_parameter_set_rbsp( ) { | Descriptor |
|---|---|
| adaptation_parameter_set_id | u(5) |
| aps_params_type | u(3) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| aps_extension_flag | u(1) |
| if( aps_extension_flag ) | |
| while( more_rbsp_data( ) ) | |
| aps_extension_data_flag | u(1) |
| rbsp_trailing_bits( ) | |
| } | |

When APS is signaled, the syntax aps_params_type is coded to identify the type of parameters (ALF, LMCS or scaling matrices). The parameters of ALF are coded using alf_data( ) function:

| alf_data( ) { | Descriptor |
|---|---|
| alf_luma_filter_signal_flag | u(1) |
| alf_chroma_filter_signal_flag | u(1) |
| alf_cc_cb_filter_signal_flag | u(1) |
| alf_cc_cr_filter_signal _flag | u(1) |
| if( alf_luma_filter_signal_flag ) { | |
| ... | |
| } | |
| if( alf_chroma_filter_signal_flag ) { | |
| ... | |
| } | |
| if( alf_cc_cb_filter_signal_flag ) { | |
| ... | |
| } | |
| if( alf_cc_cr_filter_signal_flag) { | |
| ... | |
| } | |
| } | |

alf_luma_filter_signal_flag equal to 1 specifies that a luma filter set is signalled. alf_luma_filter_signal_flag equal to 0 specifies that a luma filter set is not signalled.
alf_chroma_filter_signal_flag equal to 1 specifies that a chroma filter is signalled. alf_chroma_filter_signal_flag equal to 0 specifies that a chroma filter is not signalled. When ChromaArrayType is equal to 0, alf_chroma_filter_signal_flag shall be equal to 0.
alf_cc_cb_filter_signal_flag equal to 1 specifies that cross-component filters for the Cb colour component are signalled. alf_cc_cb_filter_signal_flag equal to 0 specifies that cross-component filters for Cb colour component are not signalled. When ChromaArrayType is equal to 0, alf_cc_cb_filter_signal_flag shall be equal to 0.
alf_cc_cr_filter_signal_flag equal to 1 specifies that cross-component filters for the Cr colour component are signalled. alf_cc_cr_filter_signal_flag equal to 0 specifies that cross-component filters for the Cr colour component are not signalled. When ChromaArrayType is equal to 0, alf_cc_cr_filter_signal_flag shall be equal to 0.

That is, four flags are coded to indicate which type of data are signaled: luma filter, chroma filter, cross-component filter for the Cb component, cross-component filter for the Cr component. Clearly, if only luma is supported, the three following flags need to be coded as zero:
alf_chroma_filter_signal_flag
alf_cc_cb_filter_signal_flag
alf_cc_cr_filter_signal_flag

The parameters of LMCS are coded in the following way:

| lmcs_data( ) { | Descriptor |
|---|---|
| lmcs_min_bin_idx | ue(v) |
| lmcs_delta_max_bin_idx | ue(v) |
| lmcs_delta_cw_prec_minus1 | ue(v) |
| for( i = lmcs_min_bin_idx; i <= LmcsMaxBinldx; i++ ) { | |
| lmcs_delta_abs_cw[ i ] | u(v) |
| if( lmcs_delta_abs_cw[ i ] > 0 ) | |
| lmcs_delta_sign_cw_flag[ i ] | u(1) |
| } | |
| lmcs_delta_abs_crs | u(3) |
| if( lmcs_delta_abs_crs > 0 ) | |
| lmcs_delta_sign_crs_flag | u(1) |
| } | |

lmcs_min_bin_idx specifies the minimum bin index used in the luma mapping with chroma scaling construction process. The value of lmcs_min_bin_idx shall be in the range of 0 to 15, inclusive.
lmcs_delta_max_bin_idx specifies the delta value between 15 and the maximum bin index LmcsMaxBinIdx used in the luma mapping with chroma scaling construction process. The value of lmcs_delta_max_bin_idx shall be in the range of 0 to 15, inclusive. The value of LmcsMaxBinldx is set equal to 15—lmcs_delta_max_bin_idx. The value of LmcsMaxBinldx shall be greater than or equal to lmcs_min_bin_idx.
lmcs_delta_cw_prec_minus1 plus 1 specifies the number of bits used for the representation of the syntax lmcs_delta_abs_cw[i]. The value of lmcs_delta_cwprec_minus1 shall be in the range of 0 to BitDepth−2, inclusive.
lmcs_delta_abs_cw[i] specifies the absolute delta codeword value for the ith bin.
lmcs_delta_sign_cw_flag[i] specifies the sign of the variable lmcsDeltaCW[i] . . .
lmcs_delta_abs_crs specifies the absolute codeword value of the variable lmcsDeltaCrs. The value of lmcs_delta_abs_crs shall be in the range of 0 and 7, inclusive. When not present, lmcs_delta_abs_crs is inferred to be equal to 0.
lmcs_delta_sign_crs_flag specifies the sign of the variable lmcsDeltaCrs. When not present, lmcs_delta_sign_crs_flag is inferred to be equal to 0. . . .

In lmcs_data( ), the syntax elements related to luma mapping are signaled first: lmcs_min_bin_idx, lmcs_delta_max_bin_idx, lmcs_delta_cw_prec_minus1, lmcs_delta_abs_cw, and lmcs_delta_sign_cw_flag. These are used to construct a piece-wise linear function to map the luma values to new values with better coverage of the coding space. The chroma scaling part consist of two syntax elements: lmcs_delta_abs_crs and lmcs_delta_sign_crs_flag. The chroma part is scaled by a value computed by lmcs_delta_abs_crs and a look-up table mapping the value of lmcs_delta_abs_cw with a sign determined by lmcs_delta_sign_crs_flag.

The scaling matrices data are coded in the following way:

| scaling_list_data( ) { | Descriptor |
|---|---|
| scaling_matrix_for_lfnst_disabled flag | u(1) |
| scaling_list_chroma_present_flag | u(1) |
| for( id = 0; id < 28; id ++ ) | |
| matrixSize = (id < 2 ) ? 2 : ( ( id < 8 ) ? 4 : 8 ) | |
| if( scaling_list_chroma_present_flag \| \| ( id % 3 = = 2 ) | |
| \| \| (id = = 27 ) ) { | |
| scaling_list_copy_mode_flag[ id ] | u(1) |
| if( ! scaling_list_copy_mode_flag[ id ] ) | |
| scaling_list_pred_mode_flag[ id ] | u(1) |
| if( ( scaling_list_copy_mode_flag[ id ] \| \| | |
| scaling_list_pred_mode_flag[ id ]) && | |
| id != 0 && id != 2 && id != 8 ) | |
| scaling_list_pred_id_delta[ id ] | ue(v) |
| if( !scaling_list_copy_mode_flag[ id ] ) { | |
| nextCoef = 0 | |
| if( id > 13 ) { | |
| scaling_list_dc_coef[ id − 14 ] | se(v) |
| nextCoef += scaling_list_dc_coef[ id − 14 ] | |
| } | |
| for( i = 0; i < matrixSize * matrixSize; i++ ) { | |
| x = DiagScanOrder[ 3 ][ 3 ][ i ][ 0 ] | |
| y = DiagScanOrder[ 3 ][ 3 ][ i ][ l ] | |
| if( !( id > 25 && x >= 4 && y >= 4 ) ) { | |
| scaling_list_delta_coef[ id ][ i ] | se(v) |
| nextCoef += scaling_list_delta_coef[ id ][ i ] | |
| } | |
| ScalingList[ id ][ i ] = nextCoef | |
| } | |
| } | |
| } | |
| } | |
| } | |

scaling_list_chroma_present_flag equal to 1 specifies that chroma scaling lists are present in scaling_list_data( ). scaling_list_chroma_present_flag equal to 0 specifies that chroma scaling lists are not present in scaling_list_data( ). It is a requirement of bitstream conformance that scaling_list_chroma_present_flag shall be equal to 0 when ChromaArrayType is equal to 0, and shall be equal to 1 when ChromaArrayType is not equal to 0.

The scaling list data function contains a flag to check whether chroma scaling lists are present in scaling_list_data( ). This flag, scaling_list_chroma_present_flag, is coded as zero if the chroma scaling lists are not present and therefore the corresponding chroma data are not coded. This is different from ALF and LMCS where no such control exists.

In VVC, there are two formats where monochrome processing is performed for each color component. The first is chroma format of 4:0:0 where only luma components exist. That is, all chroma related syntax and code are not used. The second is 4:4:4 format when separable color plane is activated. In this case, the chroma components are treated as independent luma component. That is, VVC behaves as if no chroma at all and no chroma related tools are used. The configuration corresponds to the SPS flag separate_colour_plane_flag, which is coded as follows:

| seq_parameter_set_rbsp( ) { | Descriptor |
|---|---|
| ... | |
| chroma_format_idc | u(2) |
| if( chroma_format_idc = = 3 ) | |
| separate_colour_plane_flag | u(1) |
| ... | |

chroma_format_idc specifies the chroma sampling relative to the luma sampling as specified in clause 6.2.
separate_colour_plane_flag equal to 1 specifies that the three colour components of the 4:4:4 chroma format are coded separately. separate_colour_plane_flag equal to 0 specifies that the colour components are not coded separately. When separate_colour_plane_flag is not present, it is inferred to be equal to 0. When separate_colour_plane_flag is equal to 1, the coded picture consists of three separate components, each of which consists of coded samples of one colour plane (Y, Cb, or Cr) and uses the monochrome coding syntax. In this case, each colour plane is associated with a specific colour_plane_id value.

In the VVC specification, a variable named ChromaArrayType is used to distinguish this case (if chroma is available). It is computed as:
If separate_colour_plane_flag is equal to 0, ChromaArrayType is set equal to chroma_format_idc (0-Monochrome, 1-4:2:0, 2-4:2:2, 3-4:4:4).
Otherwise (separate_colour_plane_flag is equal to 1), ChromaArrayType is set equal to 0.

For scaling matrices, the check for chroma format was added in the January 2020 meeting (see H. Zhang, et al., “AHG15: Improvement for Quantization Matrix Signaling,” Document: JVET-Q0505, Joint Video Experts Team (JVET) of ITU-T SG 16 WP 3 and ISO/IEC JTC 1/SC 29/WG 11, 17th Meeting: Brussels, BE, 7-17 Jan. 2020). Before that, the scaling matrices parameters were coded regardless of the chroma format.

The present embodiments are directed to reduce redundancy in coding parameters related to chroma when coding parameters for chroma component do not exist (ChromaArrayType=0). In one embodiment, it harmonizes ALF and LMCS with scaling matrices parameters coding where a check for the chroma type is used before coding. In the following, multiple embodiments are provided as solutions to the redundancy coding issue.

### Embodiment 1: Adding Chroma Available Flag in ALF and LMCS

In this embodiment, a flag for the availability of chroma components is coded in ALF and LMCS, as described in the following:

| alf_data( ) { | Descriptor |
|---|---|
| alf_luma_filter_signal _flag | u(1) |
| alf_chroma_present_flag | u(1) |
| if (alf_chroma_present_flag){ | |
| alf_chroma_filter_signal_flag | u(1) |
| alf_cc_cb_filte_rsignal_flag | u(1) |
| alf_cc_cr_filter_signal_flag | u(1) |
| } | |
| if( alf_luma_filter_signal_flag) { | |
| ... | |
| } | |
| if( alf_chroma_filter_signal_flag ) { | |
| ... | |
| } | |
| if( alf_cc_cb_filter_signal_flag) { | |
| ... | |
| } | |
| if( alf_cc_cr_filter_signal_flag) { | |
| ... | |
| } | |
| } | |

The semantic of the new flag is:

alf_chroma_present_flag equal to 1 specifies that chroma alf data are present in alf_data( ). alf_chroma_present_flag equal to 0 specifies that chroma alf data are not present in alf_data( ). It is a requirement of bitstream conformance that alf_chroma_present_flag shall be equal to 0 when ChromaArrayType is equal to 0, and shall be equal to 1 when ChromaArrayType is not equal to 0.

Further, the following flags shall be inferred to zero if not available

alf_chroma_filter_signal_flag equal to 1 specifies that a chroma filter is signalled. alf_chroma_filter_signal_flag equal to 0 specifies that a chroma filter is not signalled. When ChromaArrayType is equal to 0, alf_chroma_filter_signal_flag shall be equal to 0. When not present, alf_chroma_filter_signal_flag value is inferred to be equal to 0.
alf_cc_cb_filter_signal_flag equal to 1 specifies that cross-component filters for the Cb colour component are signalled. alf_cc_cb_filter_signal_flag equal to 0 specifies that cross-component filters for Cb colour component are not signalled. When ChromaArrayType is equal to 0, alf_cc_cb_filter_signal_flag shall be equal to 0. When not present, alf_cc_cb_filter_signal_flag value is inferred to be equal to 0.
alf_cc_cr_filter_signal_flag equal to 1 specifies that cross-component filters for the Cr colour component are signalled. alf_cc_cr_filter_signal_flag equal to 0 specifies that cross-component filters for the Cr colour component are not signalled. When ChromaArrayType is equal to 0, alf_cc_cr_filter_signal_flag shall be equal to 0. When not present, alf_cc_cr_filter_signal_flag value is inferred to be equal to 0.

The advantage of this method is that instead of coding three flags with zero, one flag (alf_chroma_present_flag) is coded as zero for ChromaArrayType 0.

Similarly, a flag is added for LMCS:

| lmcs_data( ) { | Descriptor |
|---|---|
| lmcs_min_bin_idx | ue(v) |
| lmcs_delta_max_bin_idx | ue(v) |
| lmcs_delta_cw_prec_minus1 | ue(v) |
| for( i = lmcs_min_bin_idx; i <= LmcsMaxBinldx; i++ ) { | |
| lmcs_delta_abs_cw[ i ] | u(v) |
| if( lmcs_delta_abs_cw[ i ] > 0 ) | |
| lmcs_delta_sign_cw_flag[ i ] | u(1) |
| } | |
| lmcs_chroma_present_flag | u(1) |
| if(lmcs_chroma_present_flag) | |
| lmcs_delta_abs_crs | u(3) |
| if( lmcs_delta_abs_crs > 0 ) | |
| lmcs_delta_sign_crs_flag | u(1) |
| } | |

The semantic of this flag is:

lmcs_chroma_present_flag equal to 1 specifies that chroma lmcs data are present in lmcs_data( ). lmcs_chroma_present_flag equal to 0 specifies that chroma lmcs data are not present in lmcs_data( ). It is a requirement of bitstream conformance that lmcs_chroma_present_flag shall be equal to 0 when ChromaArrayType is equal to 0, and shall be equal to 1 when ChromaArrayType is not equal to 0.

The advantage here is that instead of coding 3-bit syntax (lmes_delta_abs_crs) as zero, a one-bit flag lmcs_chroma_present_flag is coded as zero when chromaArrayType is zero.

### Embodiment 2: Adding Chroma Available Flag in APS

Instead of having chroma_present_flag in ALF, LMCS and Scaling matrices function, it is proposed in this embodiment to have one flag in APS. This is a cleaner design and easier for the encoder setting. Specifically, the following modifications are done:

| adaptation_parameter_set_rbsp( ) { | Descriptor |
|---|---|
| adaptation_parameter_set_id | u(5) |
| aps_params_type | u(3) |
| aps_chroma_present_flag | u(1) |
| if( aps_params_type = = ALF_APS ) | |
| alf_data( aps_chroma_present_flag ) | |
| else if( aps_params_type = = LMCS_APS ) | |
| lmcs_data(aps_chroma_present_flag) | |
| else if( aps_params_type = = SCALING_APS ) | |
| scaling_list_data(aps_chroma_present_flag) | |
| aps_extension_flag | u(1) |
| if( aps_extension_flag) | |
| while( more_rbsp_data( ) ) | |
| aps_extension_data_flag | u(1) |
| rbsp_trailing_bits( ) | |
| } | |

The semantic of this flag is:

aps_chroma_present_flag equal to 1 specifies that chroma data related to ALF, LMCS and Scaling Matrices are present in APS. aps_chroma_present_flag equal to 0 specifies that chroma data related to ALF, LMCS and Scaling Matrices are not present in APS. It is a requirement of bitstream conformance that aps_chroma_present_flag shall be equal to 0 when ChromaArrayType is equal to 0, and shall be equal to 1 when ChromaArrayType is not equal to 0.

Then the individual function is modified as follows:

| alf_data(aps_chroma_present_flag ) { | Descriptor |
|---|---|
| alf_luma_filter_signal_flag | u(1) |
| if (aps_chroma_present_flag){ | |
| alf_chroma_filter_signal_flag | u(1) |
| alf_cc_cb_filter_signal_flag | u(1) |
| alf_cc_cr_filter_signal_flag | u(1) |
| } | |
| if( alf_luma_filter_signal_flag) { | |
| ... | |
| } | |
| if( alf_chroma_filter_signal_flag ) { | |
| ... | |
| } | |
| if( alf_cc_cb_filter_signal_flag ) { | |
| ... | |
| } | |
| if( alf_cc_cr_filter_signal_flag) { | |
| ... | |
| } | |
| } | |

| lmcs_data(aps_chroma_present_flag ) { | Descriptor |
|---|---|
| lmcs_min_bin_idx | ue(v) |
| lmcs_delta_max_bin_idx | ue(v) |
| lmcs_delta_cw_prec_minus1 | ue(v) |
| for( i = lmcs_min_bin_idx; i <= LmcsMaxBinIdx; i++ ) { | |
| lmcs_delta_abs_cw[ i ] | u(v) |
| if( lmcs_delta_abs_cw[ i ] > 0 ) | |
| lmcs_delta_sign_cw_flag[ i ] | u(1) |
| } | |
| if(aps_chroma_present_flag) | |
| lmcs_delta_abs_crs | u(3) |
| if( lmcs_delta_abs_crs > 0 ) | |
| lmcs_delta_sign_crs_flag | u(1) |
| } | |

| scaling_list_data(aps_chroma_present_flag) { | Descriptor |
|---|---|
| scaling_matrix_for_lfnst_disabled_flag | u(1) |
| [symbol] | [symbol] |
| for( id = 0; id < 28; id ++ ) | |
| matrixSize = (id < 2 ) ? 2 : ( ( id < 8 ) ? 4 : 8 ) | |
| if(aps_chroma_present_flag | |
| [symbol] \| \| (id% 3 = = 2) \| \| | |
| (id = = 27 ) ) { | |
| scaling_list_copy_mode_flag[ id ] | u(1) |
| if( !scaling_list_copy_mode_flag[ id ] ) | |
| scaling_list_pred_mode_flag[ id ] | u(1) |
| if( ( scaling_list_copy_mode_flag[ id ] \| \| | |
| scaling_list_pred_mode_flag[ id ]) && | |
| id != 0 && id != 2 && id != 8 ) | |
| scaling_list_pred_id_delta[ id ] | ue(v) |
| if( !scaling_list_copy_mode_flag[ id ] ) { | |
| nextCoef = 0 | |
| if( id > 13 ) { | |
| scaling_list_dc_coef[ id − 14 ] | se(v) |
| nextCoef += scaling_list_dc_coef[ id − 14 ] | |
| } | |
| for( i = 0; i < matrixSize * matrixSize; i++ ) { | |
| x = DiagScanOrder[ 3 ][ 3 ][ i ][ 0 ] | |
| y = DiagScanOrder[ 3 ][ 3 ][ i ][ l ] | |
| if( !( id > 25 && x >= 4 && y >= 4 ) ) { | |
| scaling_list_delta_coef[ id ][ i ] | se(v) |
| nextCoef += scaling_list_delta_coef[ id ][ i ] | |
| } | |
| ScalingList[ id ][ i ] = nextCoef | |
| } | |
| } | |
| } | |
| } | |
| } | |

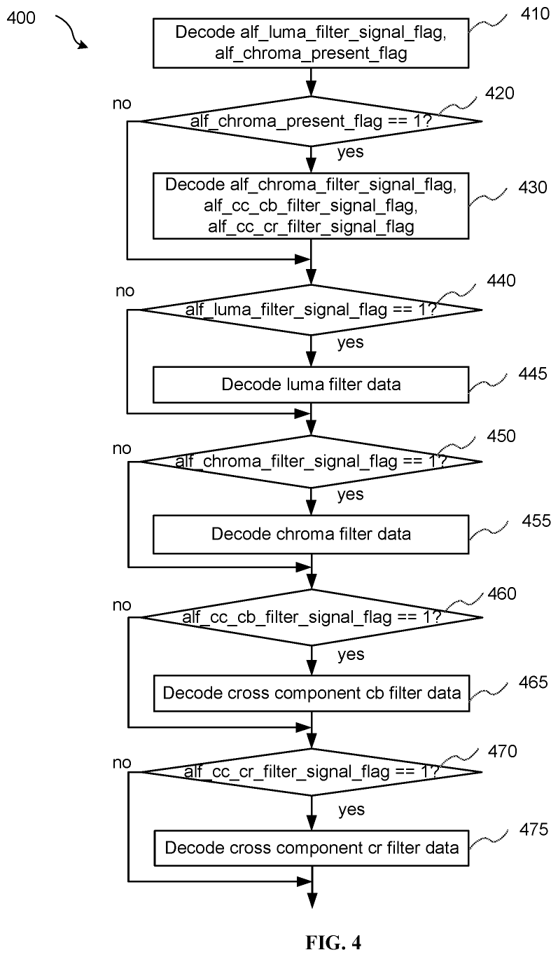

FIG. 4 illustrates a process 400 for decoding ALF filter data, according to an embodiment. The input to process 400 is a bitstream to be decoded, and the output is the ALF filter parameters. Initially, all flags can be set to 0. At step 410, the decoder decodes syntax elements alf_luma_filter_signal_flag and alf_chroma_present_flag. If alf_chroma_present_flag is equal to 1 (420), the decoder further decodes (430) syntax elements alf_chroma_filter_signal_flag, alf_cc_cb_filter_signal_flag, and alf_cc_cr_filter_signal_flag.

If alf_luma_filter_signal_flag is equal to 1 (440), the decoder decodes (445) luma filter data. If alf_chroma_filter_signal_flag is equal to 1 (450), the decoder decodes (455) chroma filter data. If alf_cc_cb_filter_signal_flag is equal to 1 (460), the decoder decodes (465) cross component filter data for Cb component. If alf_cc_cr_filter_signal_flag is equal to 1 (470), the decoder decodes (475) cross component filter data for the Cr component.

Here at step 410, alf_luma_filter_signal_flag is directly decoded from the bitstream. In another embodiment, alf_luma_filter_signal_flag can be derived from another syntax element, such as setting to aps_chroma_present_flag of the APS as described before.

FIG. 4 illustrates the decoding process. The encoding process is similar, while the decoding of syntax elements is replaced by the encoding of syntax elements.

In the above, we describe adding or modifying flags in the Adaptation Parameter Set. It should be noted that these flags can be presented in other syntax structures, while the flags are used to indicate whether chroma ALF/LMCS data are present in the bitstream. Flags for other coding tools can also be added or modified to indicate whether chroma coding parameters are present for these coding tools.

Control of LMCS

As mentioned above, HEVC or VVC can include various levels of syntax or parameters and various tools associated with the codec. As an example, various syntax elements involving control parameters are organized in sets of parameters such as a Video Parameter Set (VPS), a Picture Parameter Set (PPS) and a Sequence Parameter Set (SPS). One or more parameters or sets of parameters can be associated with a particular tool included within the codec's features. For example, one such tool provided in VVC is designated “luma mapping and chroma scaling” (LMCS). This tool is made of two parts: luma mapping and chroma residual scaling. Chroma residual scaling can only be used when luma mapping is enabled. Syntax elements are specified in the VVC specification at the SPS level, at the slice level (slice header) and at the picture level (picture header) to control these tools, e.g., to control activation of a tool.

In general, at least one embodiment described herein involves methods, apparatus and devices providing for improved control of a tool such as LMCS. At least one embodiment can involve providing control features to address incomplete aspects of current control syntax approaches. At least one embodiment can involve providing for slice level control of LMCS including slice level control lacking in current approaches to chroma residual scaling.

In VVC draft 8, the LMCS tool is controlled by SPS flag as follows:

| seq_parameter_set_rbsp( ) { | Descriptor |
|---|---|
| ... | |
| sps lmcs enabled flag | u(1) |
| ... | |

If LMCS is enabled (sps_lmcs_enabled_flag equal to 1), LMCS can be controlled at picture level using the picture header (PH):

| picture_header_structure( ) { | Descriptor |
|---|---|
| ... | |
| if( sps_lmcs_enabled_flag ) { | |
| ph_lmcs_enabled_flag | u(1) |
| if( ph_lmcs_enabled_flag ) { | |
| ph_lmcs_aps_id | u(2) |
| if( ChromaArrayType != 0 ) | |
| ph_chroma_residual_scale_flag | u(1) |
| } | |
| } | |
| if( sps_scaling_list_enabled_flag ) { | |

That is, at PH level, luma mapping can be enabled or disabled by the flag ph lmcs enabled flag and chroma scaling can be enabled or disabled by the flag ph_chroma_residual_scale_flag.

At the slice level, there exists a single slice header (SH) flag that enables or disables both luma mapping and chroma scaling. Specifically, the SH specification is as follows:

| slice_header( ) { | Descriptor |
|---|---|
| ... | |
| if( ph_lmcs_enabled_flag) | |
| slice_lmcs_enabled_flag | u(1) |
| ... | |

That is, slice_lmcs_enabled_flag disables totally the LMCS tool. This is unlike the PH flags, which can disable either luma mapping or chroma scaling. In the decoding process, this flag is used as follows:

The semantics of various examples of syntax elements involved in the explanation of the examples of embodiments described below are as follows:

ph_lmcs_enabled_flag equal to 1 specifies that luma mapping with chroma scaling is enabled for all slices associated with the PH. ph_lmcs_enabled_flag equal to 0 specifies that luma mapping with chroma scaling may be disabled for one, or more, or all slices associated with the PH. When not present, the value of ph_lmcs_enabled_flag is inferred to be equal to 0.
ph_chroma_residual_scale_flag equal to 1 specifies that chroma residual scaling is enabled for the all slices associated with the PH. ph_chroma_residual_scale_flag equal to 0 specifies that chroma residual scaling may be disabled for one, or more, or all slices associated with the PH. When ph_chroma_residual_scale_flag is not present, it is inferred to be equal to 0.
slice_lmcs_enabled_flag equal to 1 specifies that luma mapping with chroma scaling is enabled for the current slice. slice_lmcs_enabled_flag equal to 0 specifies that luma mapping with chroma scaling is not enabled for the current slice. When slice_lmcs_enabled_flag is not present, it is inferred to be equal to 0.

In VVC draft 8, the general switching between luma and chroma part is provided as follows.

### 8.7.5 Picture Reconstruction Process

### 8.7.5.1 General

Depending on the value of slice_lmcs_enabled_flag, the following applies:
If slice_lmcs_enabled_flag is equal to 0, the (nCurrSw)x(nCurrSh) block of the reconstructed samples recSamples at location (xCurr, yCurr) is derived as follows for i=0 . . . nCurrSw−1, j=0 . . . nCurrSh−1:

recSamples[xCurr+i][yCurr+j]=Clip1(predSamples[i][j]+resSamples[i][j]) (1227)
Otherwise (slice_lmcs_enabled_flag is equal to 1), the following applies:
If cIdx is equal to 0, the following applies:
   The picture reconstruction with mapping process for luma samples as specified in clause 8.7.5.2 is invoked with the luma location (xCurr, yCurr), the block width nCurrSw and height nCurrSh, the predicted luma sample array predSamples, and the residual luma sample array resSamples as inputs, and the output is the reconstructed luma sample array recSamples.
   Otherwise (cIdx is greater than 0), the picture reconstruction with luma dependent chroma residual scaling process for chroma samples as specified in clause 8.7.5.3 is invoked with the chroma location (xCurr, yCurr), the transform block width nCurrSw and height nCurrSh, the coded block flag of the current chroma transform block tuCbfChroma, the predicted chroma sample array predSamples, and the residual chroma sample array resSamples as inputs, and the output is the reconstructed chroma sample array recSamples.

For luma part, it is used in the following locations.
1—For the inter prediction mode (weighted prediction):

### 8.5.6.7 Weighted Sample Prediction Process for Combined Merge and Intra Prediction

When cIdx is equal to 0 and slice_lmcs_enabled_flag is equal to 1, predSamplesInter[x][y] with x=0 . . . cbWidth−1 and y=0 . . . cbHeight−1 are modified as follows:

idxY=predSamplesInter[x][y]>>Log2(OrgCW)

predSampleslnter[x][y]=Clip1(LmcsPivot[idxY]+ (1028)

(ScaleCoeff[idxY]*(predSamplesInter[x][y]−InputPivot[idxY])+(1<<10))>>11)

2—For the Other Prediction Modes:

### 8.8.2.2 Inverse Mapping Process for a Luma Sample

Input to this process is a luma sample lumaSample.

Output of this process is a modified luma sample invLumaSample .

The value of invLumaSample is derived as follows:
If slice_lmcs_enabled_flag of the slice that contains the luma sample lumaSample is equal to 1, the following ordered steps apply:
1. The variable idxYlnv is derived by invoking the identification of piece-wise function index process for a luma sample as specified in clause 8.8.2.3 with lumaSample as the input and idxYInv as the output.
2. The variable invSample is derived as follows:

invSample=InputPivot[idxYInv]+(InvScaleCoeff[idxYInv]*(lumaSample−LmcsPivot[idxYInv])+(1<<10))>>11 (1241)
3. The inverse mapped luma sample invLumaSample is derived as follows:

invLumaSample=Clip1(invSample) (1242)
Otherwise, invLumaSample is set equal to lumaSample.

The chroma part is addressed as follows.

8.7.5.3 Picture Reconstruction with Luma Dependent Chroma Residual Scaling Process for Chroma Samples

Inputs to this process are:
a chroma location (xCurr, yCurr) of the top-left chroma sample of the current chroma transform block relative to the top-left chroma sample of the current picture,
a variable nCurrSw specifying the chroma transform block width,
a variable nCurrSh specifying the chroma transform block height,
a variable tuCbfChroma specifying the coded block flag of the current chroma transform block,
an (nCurrSw)x(nCurrSh) array predSamples specifying the chroma prediction samples of the current block,
(nCurrSw)×(nCurrSh) array resSamples specifying the chroma residual samples of the current block,

Output of this process is a reconstructed chroma picture sample array recSamples.

The variable sizeY is set equal to Min(CtbSizeY, 64).

The reconstructed chroma picture sample recSamples is derived as follows for i=0 . . . nCurrSw−1, j=0 . . . nCurrSh−1:
If one or more of the following conditions are true, recSamples[xCurr+i][yCurr+j] is set equal to Clip1(predSamples[i][j]+resSamples[i][j]):
ph_chromaresidual_scale_flag is equal to 0.
slice_lmcs_enabled_flag is equal to 0.
nCurrSw*nCurrSh is less than or euqal to 4.
tu_cbf_cb[xCurr][yCurr] is equal to 0 and tu_cbf_cr[xCurr][yCurr] is equal to 0.

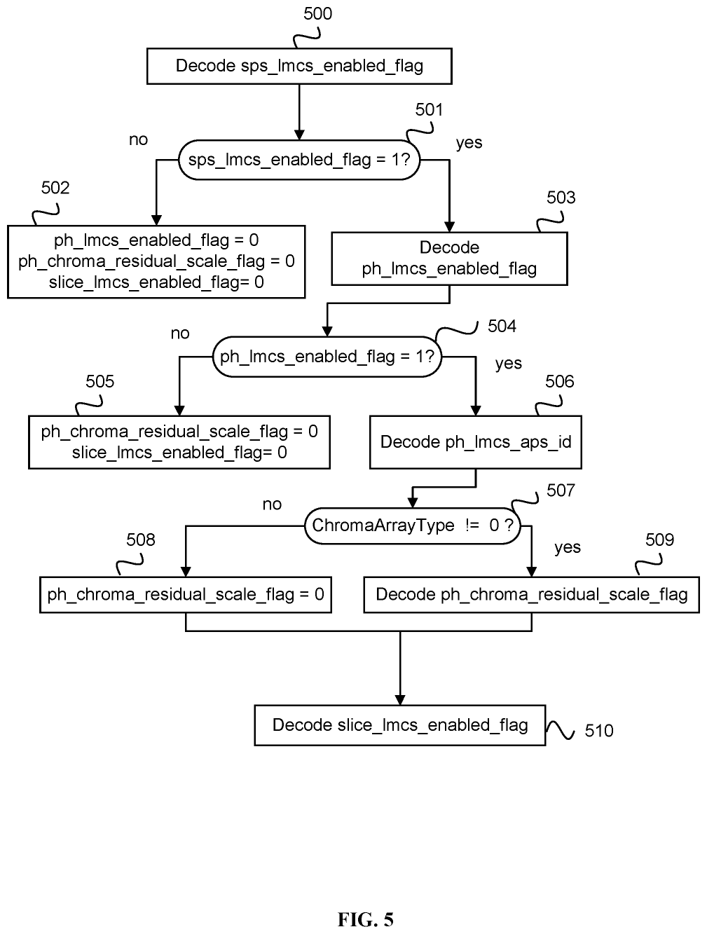

FIG. 5 illustrates an example of a process for activating or de-activating the luma mapping and the chroma residual scaling based on VVC. In FIG. 5, at step 500 the flag sps_lmcs_enabled_flag is decoded. Step 501 checks the value of the flag sps_lmcs_enabled_flag. If sps_lmcs_enabled_flag is equal to 0, LMCS is deactivated at the sequence level, and ph_lmcs_enabled_flag, ph_chroma_residual_scale_flag, slice_lmcs_enabled_flag set equal to 0 (step 502). If sps_lmcs_enabled_flag is equal to 1, the flag ph_lmcs_enabled_flag is decoded in step 503.

Step 504 checks the value of the flag ph_lmcs_enabled_flag. If ph_lmcs_enabled_flag is equal to 0, LMCS is deactivated at the picture level, and flags ph_chroma_residual_scale flag, slice_lmcs_enabled_flag set equal to 0 (step 505). If ph_lmcs_enabled_flag is equal to 1, the syntax element ph_lmcs_aps_id is decoded in step 506. Then in step 507, the value of the parameter ChromaArrayType is checked. If ChromaArrayType is equal to 0, ph_chroma_residual_scale_flag is set equal to 0 (step 508). If ChromaArrayType is not equal to 0, ph_chroma_residual_scale_flag is decoded (step 509). Finally, if ph_lmcs_enabled_flag is equal to 1, slice lmcs enabled flag is decoded (step 510).

Thus, slice_lmcs_enabled_flag disables both the luma and chroma processes of LMCS. Doing so is not consistent with the picture-level control of the luma mapping and of the chroma residual scaling using different flags. If at the slice level, LMCS is disabled, chroma residual scaling is therefore also deactivated even when it was signaled to be active at the PH level. But there is no means to control the chroma residual scaling at slice level. At least one embodiment involves providing control information related to the chroma part of LMCS. At least one embodiment involves providing a slice level flag to disable the chroma part of LMCS. At least one embodiment involves providing control information for LMCS based on unifying the control features with PH, e.g., where two flags are used to control LMCS luma and chroma parts

In general, at least one example of an embodiment involves improving control of LMCS. At least one example of an embodiment involves providing the same mechanism at both PH and slice header. At least one example of an embodiment involves adding an SH flag to control the chroma part of LMCS, e.g., adding a slice_chroma_residual_scale_flag. An example of an embodiment is illustrated based on a change of the VVC draft 8 specification as illustrated by the following underlined portions:

| slice_header( ) { | Descriptor |
|---|---|
| ... | |
| if( ph_lmcs_enabled_flag ){ | |
| slice_lmcs_enabled_flag | u(1) |
| if( ph_chroma_residual_scale_flag && | |
| slice_lmcs_enabled_flag ) | |
| slice_chroma_residual_scale_flag | u(1) |
| } | |
| ... | |

The semantic of this flag is

slice_chroma_residual_scale_flag equal to 1 specifies that chroma residual scaling is enabled for the current slice. slice_chroma_residual_scale_flag equal to 0 specifies that chroma residual scaling is not enabled for the current slice. When slice_chroma_residual_scale_flag is not present, it is inferred to be equal to 0.

In the decoding process, the flag is used as follows:

### 8.7.5 Picture Reconstruction Process

### 8.7.5.1 General

Depending on the value of slice_lmcs_enabled_flag, the following applies:
If slice_lmcs_enabled_flag is equal to 0, the (nCurrSw)x(nCurrSh) block of the reconstructed samples recSamples at location (xCurr, yCurr) is derived as follows for i=0 . . . nCurrSw—1, j=0 . . . nCurrSh−1:recSamples[xCurr+i][yCurr+j]=Clip1(predSamples[i][j]+resSamples[i][j]) (1227)Otherwise (slice_lmcs_enabled_flag is equal to 1), the following applies: [symbol]
   The picture reconstruction with mapping process for luma samples as specified in clause 8.7.5.2 is invoked with the luma location (xCurr, yCurr), the block width nCurrSw and height nCurrSh, the predicted luma sample array predSamples, and the residual luma sample array resSamples as inputs, and the output is the reconstructed luma sample array recSamples.
   Otherwise (cIdx is greater than 0) and slice_chroma_residual_scale_flag is equal to one, the picture reconstruction with luma dependent chroma residual scaling process for chroma samples as specified in clause 8.7.5.3 is invoked with the chroma location (xCurr, yCurr), the transform block width nCurrSw and height nCurrSh, the coded block flag of the current chroma transform block tuCbfChroma, the predicted chroma sample array predSamples, and the residual chroma sample array resSamples as inputs, and the output is the reconstructed chroma sample array recSamples.
      8.7.5.3 Picture Reconstruction with Luma Dependent Chroma Residual Scaling Process for Chroma Samples
      Inputs to this Process Are:
a chroma location (xCurr, yCurr) of the top-left chroma sample of the current chroma transform block relative
to the top-left chroma sample of the current picture,
a variable nCurrSw specifying the chroma transform block width,
a variable nCurrSh specifying the chroma transform block height,
a variable tuCbfChroma specifying the coded block flag of the current chroma transform block,
an (nCurrSw)x(nCurrSh) array predSamples specifying the chroma prediction samples of the current block,
an (nCurrSw)x(nCurrSh) array resSamples specifying the chroma residual samples of the current block,

Output of this process is a reconstructed chroma picture sample array recSamples.

The variable sizeY is set equal to Min(CtbSizeY, 64).

The reconstructed chroma picture sample recSamples is derived as follows for i=0 . . . nCurrSw−1, j=0 . . . nCurrSh−1:
If one or more of the following conditions are true, recSamples[xCurr+i][yCurr+j] is set equal to Clip1 (predSamples[i][j]+resSamples[i][j]): [symbol] [symbol]
slice_chroma_residual_scale_flag is equal to 0
nCurrSw*nCurrSh is less than or euqal to 4.
tu_cbf_cb[xCurr][yCurr] is equal to 0 and tu_cbf_cr[xCurr][yCurr] is equal to 0.

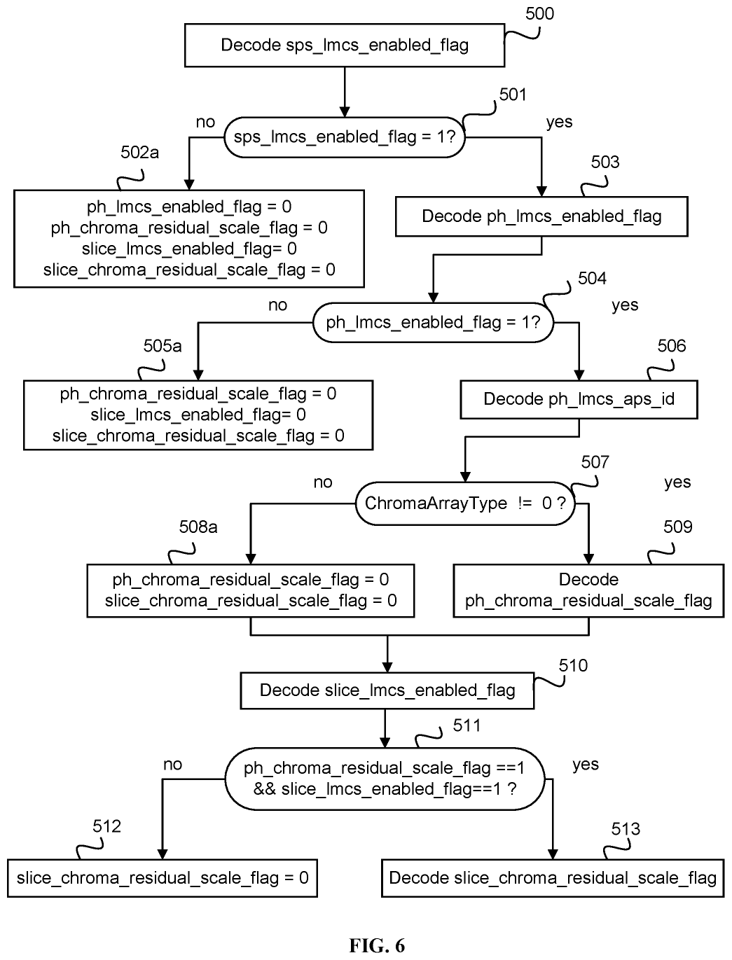

FIG. 6 illustrates an example of an embodiment including changes with respect to the example of FIG. 5. Steps 502, 505 and 508 are modified into steps 502a, 505a and 508a, respectively, thereby adding a step of setting slice_chroma_residual_scale_flag equal to 0. After step 510, step 502 is modified into step 502a, with the introduction a step of setting slice_chroma_residual_scale_flag equal to 0. Steps 511, 512, 513 are added. Step 511 checks the value of ph_chroma_residual_scale_flag and slice_lmcs_enabled_flag. If both flags are equal to 1, flag slice_chroma_residual_scale_flag is decoded in step 513. If not, flag slice_chroma_residual_scale_flag is set equal to 0 in step 512.

In an example of an embodiment, the slice level flags slice_lmcs_enabled_flag and slice_chroma_residual_scale_flag are specified. However, the control of chroma residual scaling in slice header is only based on the PH flag ph_chroma_residual_scale_flag. Even if slice_lmcs_enabled_flag is equal to 0, slice_chroma_residual_scale_flag can be signalled if ph_chroma_residual_scale_flag is equal to 1. An example of picture and slice header syntax in accordance with the present example of an embodiment is illustrated below.

| picture_header_structure( ) { | Descriptor |
|---|---|
| ... | |
| if( sps_lmcs_enabled_flag ) { | |
| ph_lmcs_enabled_flag | u(1) |
| if( ph_lmcs_enabled_flag) { | |
| ph_lmcs_aps_id | u(2) |
| if( ChromaArrayType != 0 ) | |
| ph_chroma_residual_scale_flag | u(1) |
| } | |
| } | |
| ... | |

| slice_header( ) { | Descriptor |
|---|---|
| ... | |
| if( ph_lmcs_enabled_flag ){ | |
| slice_lmcs_enabled_flag | u(1) |
| if( ph_chroma_residual_scale flag ) | |
| slice_chroma_residual_scale_flag | u(1) |
| } | |
| ... | |

In another example of an embodiment, the PH flag ph_chroma_residual_scale_flag is removed, and the slice level flags slice_lmcs_enabled_flag and slice_chroma_residual_scale_flag are specified. If slice_lmcs_enabled_flag is equal to 0, slice_chroma_residual_scale_flag is not decoded and set to 0. An example of picture header and slice header syntax in accordance with the present example of an embodiment is illustrated below.

| picture_header_structure( ) { | Descriptor |
|---|---|
| ... | |
| if( sps_lmcs_enabled_flag ) { | |
| ph_lmcs_enabled_flag | u(1) |
| if( ph_lmcs_enabled_flag ) { | |
| ph_lmcs_aps_id | u(2) |
| [symbol] | |
| [symbol] | [symbol] |
| } | |
| } | |
| ... | |

| slice_header( ) { | Descriptor |
|---|---|
| ... | |
| if( ph_lmcs enabled_flag ) | |
| slice_lmcs_enabled_flag | u(1) |
| if( slice_lmcs_enabled_flag ) | |
| slice_chroma_residual_scale_flag | u(1) |
| } | |
| ... | |

Luminance-Only Signaling or Intra-Only Signaling

In VVC draft 8, many non-intra high-level syntax (HLS) elements are coded regardless if all-intra profile is used. In fact, all-intra is an important profile that can be used for several applications where low delay and low complexity constraints are used and also for image coding applications. When all-intra is used, the constraint flag (intra_only_constraint_flag) is set to one. The semantic of this flag is:

intra_only_constraint_flag equal to 1 specifies that_slice type shall be equal to I. intra_only_constraint_flag equal to 0 does not impose such a constraint.

That is, at slice-header level, the slice is set as I Slice. The levels higher than slice level (picture-header, picture parameters set, etc.) are agnostic of the allowed slices types. Therefore, for all-intra profile, the inter-related syntax elements are redundantly coded. For example, the sequence parameters set (SPS) corresponding to inter tools are:

| seq_parameter_set_rbsp( ) { | Descriptor |
|---|---|
| ... | |
| sps_weighted_pred_flag | u(1) |
| sps weighted bipred flag | u(1) |
| ... | |
| long_term_ref_pics_flag | u(1) |
| inter_layer_ref_pics_present_flag | u(1) |
| sps_idr_rpl_present_flag | u(1) |
| rpl1_same_as_rpl0_flag | u(1) |
| for( i = 0; i < rpl1_same_as_rpl0_flag ? 1 : 2; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| ... | |
| sps_log2_diff_min_qt_min_cb_inter_slice | ue(v) |
| sps_max_mtt_hierarchy_depth_inter_slice | ue(v) |
| if( sps_max_mtt_hierarchy_depth_inter_slice != 0 ) { | |
| sps_log2_diff_max_bt_min_qt_inter_slice | ue(v) |
| sps_log2_diff_max_tt_min_qt_inter_slice | ue(v) |
| } | |
| ... | |
| sps_ref_wraparound_enabled_flag | u(1) |
| sps_temporal_mvp_enabled_flag | u(1) |
| if( sps_temporal_mvp_enabled_flag ) | |
| sps_sbtmvp_enabled_flag | u(1) |
| sps_amvr_enabled_flag | u(1) |
| sps_bdof_enabled_flag | u(1) |
| if( sps_bdof_enabled_flag ) | |
| sps_bdof_pic_present_flag | u(1) |
| sps_smvd_enabled_flag | u(1) |
| sps_dmvr_enabled_flag | u(1) |
| if( sps_dmvr_enabled_flag ) | |
| sps_dmvr_pic_present_flag | u(1) |
| sps_mmvd_enabled_flag | u(1) |
| } | |
| ... | |
| sps_explicit_mts_inter_enabled_flag | u(1) |
| ... | |
| six_minus_max_num_merge_cand | ue(v) |
| sps_sbt_enabled_flag | u(1) |
| sps_affine_enabled_flag | u(1) |
| if( sps_affine enabled flag ) { | |
| five_minus_max_num_subblock_merge_cand | ue(v) |
| sps_affine_type_flag | u(1) |
| if( sps_amvr_enabled_flag) | |
| sps_affine_amvr_enabled_flag | u(1) |
| sps_affine_prof_enabled_flag | u(1) |
| if( sps_affine_prof_enabled_flag ) | |
| sps_prof_pic_present_flag | u(1) |
| } | |
| ... | |
| sps_bcw_enabled_flag | u(1) |
| sps_ibc_enabled_flag | u(1) |
| if( sps_ibc_enabled_flag ) | |
| six_minus_max_num_ibc_merge_cand | ue(v) |
| sps_ciip_enabled_flag | u(1) |
| if( sps_mmvd_enabled_flag ) | |
| sps_fpel_mmvd_enabled_flag | u(1) |
| if( MaxNumMergeCand >= 2 ) { | |
| sps_gpm_enabled_flag | u(1) |
| if( sps_gpm_enabled_flag && | |
| MaxNumMergeCand >= 3 ) | |
| max_num_merge_cand_minus_max_num_gpm_ | ue(v) |
| cand | |
| } | |
| ... | |
| log2_parallel_merge_level_minus2 | ue(v) |
| ... | |

That is, there are more than 40 SPS syntax elements related to inter-tools. Compared to HEVC, only 7 elements are coded:

| seq_parameter_set_rbsp( ) { | Descriptor |
|---|---|
| ... | |
| amp_enabled_flag | u(1) |
| ... | |
| num_short_term_ref_pic_sets | ue(v) |
| for( i = 0; i < num_short_term_ref_pic_sets; i++) | |
| short_term_ref_pic_set( i ) | |
| long_term_ref_pics_present_flag | u(1) |
| if( long_term_ref_pics_present_flag ) { | |
| num_long_term_ref_pics_sps | ue(v) |
| for( i = 0; i < num_long_term_ref_pics_sps; i++ ) { | |
| It_ref_pic_poc_lsb_sps[ i ] | u(v) |
| used_by_curr pic_It_sps flag[ i ] | u(1) |
| } | |
| } | |
| sps_temporal_mvp_enable_flag | u(1) |
| ... | |

That is, the number of non-intra elements is more than 5 times higher in VVC compared to HEVC. Therefore, better coding mechanism is needed where redundant information is not coded but inferred.

Apart from SPS, same redundancy is found in picture parameters set (PPS) and also constraint flags. Specifically, for PPS, the following inter elements are coded:

| pic_parameter_set_rbsp( ) { | Descriptor |
|---|---|
| ... | |
| rpl1 idx present flag | u(1) |
| ... | |
| pps_weighted_pred_flag | u(1) |
| pps_weighted_bipred_flag | u(1) |
| ... | |
| rpl_info_in_ph_flag | u(1) |
| ... | |
| if( (pps_weighted_pred_flag \| \| pps_weighted_bipred_ | |
| flag) && rpl_info in ph flag ) | |
| wp_info_in_ph_flag | u(1) |
| .... | |
| pps_ref_wraparound_enabled_flag | u(1) |
| if( pps_ref_wraparound_enabled_flag ) | |
| pps_ref_wraparound_offset | ue(v) |
| ... | |

The constraint information related to inter are:

| general_constraint_info( ) { | Descriptor |
|---|---|
| ... | |
| no_ref_wraparound_constraint_flag | u(1) |
| no_temporal_mvp_constraint_flag | u(1) |
| no_sbtmvp_constraint flag | u(1) |
| no_amvr_constraint_flag | u(1) |
| no_bdof_constraint_flag | u(1) |
| no_dmvr_constraint_flag | u(1) |
| ... | |
| no_sbt_constraint_flag | u(1) |
| no_affine_motion_constraint_flag | u(1) |
| no_bcw_constraint_flag | u(1) |
| ... | |
| no_ciip_constraint_flag | u(1) |
| no_fpel_mmvd_constraint_flag | u(1) |
| no_gpm_constraint_flag | u(1) |
| ... | |

That is, 12 inter-specific elements need to be coded even for all-intra profile.

Similar to inter-related syntax elements, there are redundant chroma related elements that are redundant when chroma information are not available. This happens when coding chroma format YUV4:0:0 (luma only), or YUV4:4:4 with separate color plane. However, for chroma, a check is done at all levels to avoid redundant coding, with a single exception at the constraint information level. That is, the following chroma related syntax elements are always coded:

| general_constraint_info( ) { | Descriptor |
|---|---|
| ... | |
| no_ccalf_constraint_flag | u(1) |
| no_joint_cbcr_constraint_flag | u(1) |
| ... | |
| no_cclm_constraint_flag | u(1) |
| } | |

The intention of the described aspects is to remove redundant syntax elements when either all-intra profile is used, or when chroma information is not available.

Due to the large number of high-level syntax (HLS) elements, VVC supports some mechanism to avoid coding of some inter elements and chroma elements when inter pictures is disabled and/or chroma is not available. In Draft 8, a check is added in the picture header (PH) is done to code inter-related syntax elements. This is done via the flag_ph_inter_slice_allowed_flag:

| picture_header_structure( ) { | Descriptor |
|---|---|
| ... | |
| if( ph_inter_slice_allowed_flag ) { | |
| if( partition_constraints_override_flag ) { | |
| ph_log2_diff_min_qt_min_cb_inter_slice | ue(v) |
| ph_max_mtt_hierarchy_depth_inter_slice | ue(v) |
| if(ph_max_mtt_hierarchy_depth_inter_slice != 0) { | |
| ph_log2_diff_max_bt_min_qt_inter_slice | ue(v) |
| ph_log2_diff_max_tt_min_qt_inter_slice | ue(v) |
| } | |
| } | |
| if( cu_qp delta enabled flag ) | |
| ph_cu_qp_delta_subdiv_inter_slice | ue(v) |
| if( pps_cu_chroma_qp_offset_list_enabled_flag ) | |
| ph_cu_chroma_qp_offset_subdiv_inter_slice | ue(v) |
| if( sps_temporal_mvp_enabled_flag ) { | |
| ph_temporal_mvp enabled flag | u(1) |
| if( ph_temporal_mvp_enabled_flag && | |
| rpl_info_in_ph_flag ) { | |
| ph_collocated_from_l0_flag | u(1) |
| if( (ph_collocated_from_l0_flag && | |
| num_ref_entries[ 0 ][ RplsIdx[ 0 ] ] > 1 ) \| \| | |
| ( !ph_collocated_from_l0_flag && | |
| num_ref_entries[ l ][ RplsIdx[ l ] ] > 1 ) ) | |
| ph_collocated_ref_Idx | ue(v) |
| } | |
| } | |
| mvd_l1_zero_flag | u(1) |
| if( sps_fpel_mmvd_enabled_flag ) | |
| ph_fpel_mmvd_enabled_flag | u(1) |
| if( sps_bdof_pic_present_flag ) | |
| ph_disable_bdof_flag | u(1) |
| if( sps_dmvr_pic present_flag ) | |
| ph_disable_dmvr_flag | u(1) |
| if( sps_prof_pic_present_flag ) | |
| ph_disable_prof_flag | u(1) |
| if( (pps_weighted_pred_flag \| \| | |
| pps_weighted_bipred_flag) && wp_info_in_ph_flag ) | |
| pred_weight_table( ) | |
| } | |
| ... | |

One motivation behind adding this flag was to reduce the cost of coding several flags when inter coding is not used. However, such a flag is missing in higher levels (PPS, SPS and constraint flags).

The described aspects propose removing redundant coding of several HLS elements when intra-only profile is used or chroma components are not available.

### Embodiment 1: Removing Redundant Coding at Constraint Information Level

At the constraint information level, the chroma type and inter coding can be checked to remove redundant coding. This is done in the following way:

| general_constraint_info( ) { | Descriptor |
|---|---|
| ... | |
| intra_only_constraint_flag | u(1) |
| ... | |
| max_chroma_format_constraint_idc | u(2) |
| ... | |
| if (max_chroma_format_constraint_idc){ | |
| no_ccalf_constraint_flag | u(1) |
| no_joint_cbcr_constraint_flag | u(1) |
| no_cclm_constraint_flag | u(1) |
| } | |
| if (intra_only_constraint_flag !=1 ){ | |
| no_ref_wraparound_constraint_flag | u(1) |
| no_temporal_mvp_constraint_flag | u(1) |
| no_sbtmvp_constraint_flag | u(1) |
| no_amvr_constraint_flag | u(1) |
| no_bdof_constraint_flag | u(1) |
| no_dmvr_constraint_flag | u(1) |
| no_sbt_constraint_flag | u(1) |
| no_affine_motion_constraint_flag | u(1) |
| no_bcw_constraint_flag | u(1) |
| no_ciip_constraint_flag | u(1) |
| no_fpel_mmvd_constraint_flag | u(1) |
| no_gpm _constraint_flag | u(1) |
| } | |
| [symbol] | [symbol] |
| no_mts_constraint_flag | u(1) |
| [symbol] | [symbol] |
| [symbol] | [symbol] |
| [symbol] | [symbol] |
| no_ibc_constraint_flag | u(1) |
| [symbol] | [symbol] |
| [symbol] | [symbol] |
| [symbol] | [symbol] |
| ... | |

That is, if max_chroma_format_constraint_idc is not zero (chroma format is yuv400), the chroma related constraint flags are not coded. Similarly, intra_only_constraint_flag is not equal to one (not intra only coding), the inter-related constraint flags are coded.

The semantics of these flags are modified to have inferred values if not coded:

no_ccalf_constraint_flag equal to 1 specifies that sps_ccalf_enabled_flag shall be equal to 0. no_ccalf_constraint_flag equal to 0 does not impose such a constraint. When not present, the value of no_ccalf_constraint_flag is inferred to be 1.
no_joint_cbcr_constraint_flag equal to 1 specifies that sps_joint_cbcr_enabled_flag shall be equal to 0. no_joint_cbcr_constraint_flag equal to 0 does not impose such a constraint. When not present, the value of no_joint_cbcr_constraint_flag is inferred to be 1.
no_cclm_constraint_flag equal to 1 specifies that sps_cclm_enabled_flag shall be equal to 0.
no_cclm_constraint_flag equal to 0 does not impose such a constraint. When not present, the value of no_cclm_constraint_flag is inferred to be 1.
no_ref_wraparound_constraint_flag equal to 1 specifies that sps_ref_wraparound_enabled_flag shall be equal to 0. no_ref_wraparound_constraint_flag equal to 0 does not impose such a constraint. When not present, the value of no_ref_wraparound_constraint_flag is inferred to be 1.
no_temporal_mvp_constraint_flag equal to 1 specifies that sps_temporal_mvp_enabled_flag shall be equal to 0. no_temporal_mvp_constraint_flag equal to 0 does not impose such a constraint. When not present, the value of no_temporal_mvp_constraint_flag is inferred to be 1.
no_sbtmvp_constraint_flag equal to 1 specifies that sps_sbtmvp_enabled_flag shall be equal to 0. no_sbtmvp_constraint_flag equal to 0 does not impose such a constraint. When not present, the value of no_sbtmvp_constraint_flag is inferred to be 1.
no_amvr_constraint_flag equal to 1 specifies that sps_amvr_enabled_flag shall be equal to 0. no_amvr_constraint_flag equal to 0 does not impose such a constraint. When not present, the value of no_amvr_constraint_flag is inferred to be 1.
no_bdof_constraint_flag equal to 1 specifies that sps_bdof_enabled_flag shall be equal to 0. no_bdof_constraint_flag equal to 0 does not impose such a constraint. When not present, the value of no_bdof_constraint_flag is inferred to be 1.
no_dmvr_constraint_flag equal to 1 specifies that sps_dmvr_enabled_flag shall be equal to 0. no_dmvr_constraint_flag equal to 0 does not impose such a constraint. When not present, the value of no_dmvr_constraint_flag is inferred to be 1.
no_sbt_constraint_flag equal to 1 specifies that sps_sbt_enabled_flag shall be equal to 0. no_sbt_constraint_flag equal to 0 does not impose such a constraint. When not present, the value of no_sbt_constraint_flag is inferred to be 1.
no_affine_motion_constraint_flag equal to 1 specifies that sps_affine_enabled_flag shall be equal to 0. no_affine_motion_constraint_flag equal to 0 does not impose such a constraint. When not present, the value no_affine_motion_constraint_flag of is inferred to be 1.
no_bcw_constraint_flag equal to 1 specifies that sps_bcw_enabled_flag shall be equal to 0. no_bcw_constraint_flag equal to 0 does not impose such a constraint. When not present, the value of no_bcw_constraint_flag is inferred to be 1.
no_ciip_constraint_flag equal to 1 specifies that sps_ciip_enabled_flag shall be equal to 0. no_cipp_constraint_flag equal to 0 does not impose such a constraint. When not present, the value of no_ciip_constraint_flag is inferred to be 1.
no_fpel_mmvd_constraint_flag equal to 1 specifies that sps_fpel_mmvd_enabled_flag shall be equal to 0. no_fpel_mmvd_constraint_flag equal to 0 does not impose such a constraint. When not present, the value of no_fpel_mmvd_constraint_flag is inferred to be 1.
no_gpm_constraint_flag equal to 1 specifies that sps_gpm_enabled_flag shall be equal to 0. no_gpm_constraint_flag equal to 0 does not impose such a constraint. When not present, the value of no_gpm_constraint_flag is inferred to be 1.

The intra-only constraint flag currently depends on the slice level flag slice_type. This can be shifted to picture header, where ph_inter_slice_allowed_flag is employed:

intra_only_constraint_flag equal to 1 specifies that ph_inter_slice_allowed_flag shall be equal to 0. intra_only_constraint_flag equal to 0 does not impose such a constraint.

By doing so, the intra-only profile based on the picture header flag, where inter-related picture header syntax elements are not coded but inferred to be zero.

### Embodiment 2: Adding SPS Flag to Indicate Intra-Only Profile

To remove the redundant coding in the SPS, as well as the subsequent levels, an SPS flag is added to indicate if intra-only is used, alternatively expressed, if inter-coding is not allowed. On top of embodiment 1, the following modification is done to SPS:

| seq_parameter_set_rbsp( ) { | Descriptor |
|---|---|
| ... | |
| sps_inter_slice_allowed_flag | u(1) |
| if (sps_inter _slice_allowed_flag){ | |
| sps_weighted_pred_flag | u(1) |
| sps_weighted_bipred_flag | u(1) |
| } | |
| ... | |
| if (sps_inter _slice_allowed_flag){ | |
| long_term_ref_pics_flag | u(1) |
| inter_layer_ref_pics_present_flag | u(1) |
| sps_idr_rpl_present_flag | u(1) |
| rpl1_same_as_rpl0_flag | u(1) |
| for( i = 0; i < rpl1_same_as_rpl0_flag ? 1 : 2; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| } | |
| ... | |
| if (sps_inter _slice_allowed_flag){ | |
| sps_log2_diff_min_qt_min_cb_inter_slice | ue(v) |
| sps_max_mtt_hierarchy_depth_inter_slice | ue(v) |
| if( sps_max_mtt_hierarchy_depth_inter_slice != 0){ | |
| sps_log2_diff_max_bt_min_qt_inter_slice | ue(v) |
| sps_log2_diff_max_tt_min_qt_inter_slice | ue(v) |
| } | |
| } | |
| ... | |
| if (sps_inter_slice_allowed_flag) | |
| sps_ref_wraparound_enabled_flag | u(1) |
| sps_temporal_mvp_enabled_flag | u(1) |
| if( sps_temporal_mvp_enabled_flag) | |
| sps_sbtmvp_enabled_flag | u(1) |
| sps_amvr_enabled_flag | u(1) |
| sps_bdof_enabled_flag | u(1) |
| if( sps_bdof_enabled_flag) | |
| sps_bdof_pic_present_flag | u(1) |
| sps_smvd_enabled_flag | u(1) |
| sps_dmvr_enabled_flag | u(1) |
| if( sps_dmvr_enabled_flag) | |
| sps_dmvr_pic_present_flag | u(1) |
| sps_mmvd_enabled_flag | u(1) |
| } | |
| } | |
| ... | |
| if( sps_mts_enabled_flag ) { | |
| sps_explicit_mts_intra_enabled_flag | u(1) |
| if (sps_inter _slice_allowed_flag) | |
| sps_explicit_mts_inter_enabled_flag | u(1) |
| } | |
| ... | |
| if (sps_inter_slice_allowed_flag ){ | |
| six_minus_max_num_merge_cand | ue(v) |
| sps_sbt_enabled_flag | u(1) |
| sps_affine_enabled_flag | u(1) |
| if( sps_affine_enabled_flag) { | |
| five_minus_max_num_subblock_merge_cand | ue(v) |
| sps_affine_type_flag | u(1) |
| if( sps_amvr_enabled_flag) | |
| sps_affine_amvr_enabled_flag | u(1) |
| sps_affine_prof_enabled_flag | u(1) |
| if( sps_affine_prof_enabled_flag) | |
| sps_prof_pic_present_flag | u(1) |
| } | |
| } | |
| ... | |
| if (sps_inter_slice_allowed_flag){ | |
| sps_bcw_enabled_flag | u(1) |
| sps_ibc_enabled_flag | u(1) |
| if( sps_ibc_enabled_flag) | |
| six_minus_max_num_ibc_merge_cand | ue(v) |
| sps_ciip_enabled_flag | u(1) |
| if( sps_mmvd_enabled_flag) | |
| sps_fpel_mmvd_enabled_flag | u(1) |
| if( MaxNumMergeCand >= 2 ) { | |
| sps_gpm_enabled_flag | u(1) |
| if( sps_gpm_enabled_flag && | |
| MaxNumMergeCand >= 3 ) | |
| max_num_merge_cand_minus_max_num_ | ue(v) |
| gpm_cand | |
| } | |
| } | |
| ... | |
| if (sps_inter_slice_allowed_flag) | |
| log2_parallel_merge_level_minus2 | ue(v) |
| ... | |

Clearly, this method avoids coding several SPS flags. These flags shall be inferred as zero when not present.

The semantic of this flag is:

sps_inter_slice_allowed_flag equal to 0 specifies inter slices are not allowed. sps_nter_slice_allowed_flag equal to 1 specifies inter slices maybe allowed.

This added flag SPS flag can be further used to improve the picture header coding. That is, if inter-slices are not allowed, there is no need to signal at PH level if inter is allowed. Therefore, the following modifications are made:

| picture_header_structure( ) { | Descriptor |
|---|---|
| if (sps_inter _slice_allowed_flag) | |
| ph_inter_slice_allowed_flag | u(1) |
| ... | |

Its semantic is modified as follows:

ph_inter_slice_allowed_flag equal to 0 specifies that all coded slices of the picture have slice_type equal to 2. ph_inter_slice_allowed_flag equal to 1 specifies that there may or may not be one or more coded slices in the picture that have slice_type equal to 0 or 1. If not present, the value of ph_inter_slice_allowed_flag is inferred to be equal to zero.

Finally, the constraint information flag related to intra-only can be modified as follows:

intra_only_constraint_flag equal to 1 specifies that sps_inter_slice_allowed_flag shall be equal to 0. intra_only_constraint_flag equal to 0 does not impose such a constraint.

### Embodiment 3: Adding PPS Flag to Indicate Intra-Only Profile

Similar to SPS, PPS has also redundant information of inter mode. It is proposed here to add a PPS flag to indicate if inter slices are allowed:

| pic_parameter_set_rbsp( ) { | Descriptor |
|---|---|
| ... | |
| pps_inter_slice_allowed_flag | u(1) |
| if (pps_inter_slice_allowed_flag) | |
| rpl1_idx_present_flag | u(1) |
| ... | |
| if (pps_inter_slice_allowed_flag){ | |
| pps_weighted_pred_flag | u(1) |
| pps_weighted_bipred_flag | u(1) |
| } | |
| ... | |
| if (pps_inter_slice_allowed_flag) | |
| rpl_info_in_ph_flag | u(1) |
| ... | |
| if( ( pps_weighted_pred_flag \| \| | |
| pps_weighted_bipred_flag ) && rpl_info_in_ph_flag | |
| && pps_inter_slice_allowed_flag ) | |
| wp_info_in_ph_flag | u(1) |
| .... | |
| if (pps_inter_slice_allowed_flag ) | |
| pps_ref_wraparound_enabled_flag | u(1) |
| if( pps_ref_wraparound_enabled_flag ) | |
| pps_ref_wraparound_offset | ue(v) |
| ... | |

The value of non-coded flags shall be inferred to zero.

The semantic of the added flag is:

pps_inter_slice_allowed_flag equal to 0 specifies inter slices are not allowed. pps_inter_slice_allowed_flag equal to 1 specifies inter slices maybe allowed. It is requirement of bitstream conformance that pps_inter_slice_allowed_flag value is equal to sps_inter_slice_allowed_flag.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the in-loop filter, quantization and inverse quantization modules (230, 240, 265, 365, 340), of a video encoder 200 and decoder 300 as shown in FIG. 2 and FIG. 3. Moreover, the present aspects are not limited to VVC or HEVC, and can be applied, for example, to other standards and recommendations, and extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

Note that the syntax elements as used herein are descriptive terms. As such, they do not preclude the use of other syntax element names.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization matrix for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method, comprising:
decoding a syntax indicating whether chroma ALF (Adaptive Loop Filter) data are present in a bitstream;
decoding ALF filter data for a luma component of a picture; and
responsive to said chroma ALF data being present in said bitstream, decoding ALF filter data for one or more chroma components of said picture.

2. (canceled)

3. The method of claim 1, wherein said syntax is signaled in a parameter set.

4. The method of claim 3, wherein said parameter set is an Adaptation Parameter Set (APS).

5. The method of claim 1, wherein said syntax further indicates whether chroma LMCS (Luma Mapping with Chroma Scaling) data are present in said bitstream.

6. The method of claim 1, wherein said syntax further indicates whether chroma scaling list data are present in said bitstream.

7-12. (canceled)

13. An apparatus, comprising one or more processors, wherein said one or more processors are configured to:
decode a syntax indicating whether chroma ALF (Adaptive Loop Filter) data are present in a bitstream;
decode ALF filter data for a luma component of a picture; and
responsive to said chroma ALF data being present in said bitstream, decode ALF filter data for one or more chroma components of said picture.

14. (canceled)

15. The apparatus of claim 13, wherein said syntax is signaled in a parameter set.

16. The apparatus of claim 15, wherein said parameter set is an Adaptation Parameter Set (APS).

17. The apparatus of claim 13, wherein said syntax further indicates whether chroma LMCS (Luma Mapping with Chroma Scaling) data are present in said bitstream.

18. The apparatus of claim 13, wherein said syntax further indicates whether chroma scaling list data are present in said bitstream.

19-41. (canceled)

42. A method, comprising:
encoding a syntax indicating whether chroma ALF (Adaptive Loop Filter) data are present in a bitstream;
encoding ALF filter data for a luma component of a picture; and
responsive to said chroma ALF data being present in said bitstream, encoding ALF filter data for one or more chroma components of said picture.

43. The method of claim 42, wherein said syntax is signaled in a parameter set.

44. The method of claim 43, wherein said parameter set is an Adaptation Parameter Set (APS).

45. The method of claim 42, wherein said syntax further indicates whether chroma LMCS (Luma Mapping with Chroma Scaling) data are present in said bitstream.

46. The method of claim 42, wherein said syntax further indicates whether chroma scaling list data are present in said bitstream.

47. An apparatus, comprising one or more processors, wherein said one or more processors are configured to:
encode a syntax indicating whether chroma ALF (Adaptive Loop Filter) data are present in a bitstream;
encode ALF filter data for a luma component of a picture; and
responsive to said chroma ALF data being present in said bitstream, encode ALF filter data for one or more chroma components of said picture.

48. The apparatus of claim 47, wherein said syntax is signaled in a parameter set.

49. The apparatus of claim 48, wherein said parameter set is an Adaptation Parameter Set (APS).

50. The apparatus of claim 47, wherein said syntax further indicates whether chroma LMCS (Luma Mapping with Chroma Scaling) data are present in said bitstream.

51. The apparatus of claim 47, wherein said syntax further indicates whether chroma scaling list data are present in said bitstream.
